(19) United States
(12) Patent Application Publication
(10) Pub. No.: US 2025/0149257 A1
(43) Pub. Date: May 8, 2025

(54) SOLID ELECTROLYTIC CAPACITOR

(71) Applicant: Panasonic Intellectual Property Management Co., Ltd., Osaka (JP)

(72) Inventor: RIKAKO IWASAKI, Osaka (JP)

(21) Appl. No.: 19/004,024

(22) Filed: Dec. 27, 2024

Related U.S. Application Data
(63) Continuation of application No. PCT/JP2023/025549, filed on Jul. 11, 2023.

(30) Foreign Application Priority Data
Aug. 4, 2022 (JP) 2022-124670

(51) Int. Cl. H01G 9/10; H01G 9/012; H01G 9/15

(52) U.S. Cl. CPC H01G 9/10; H01G 9/012; H01G 9/15

(57) ABSTRACT

A solid electrolytic capacitor includes at least one capacitor element including an anode part and a cathode part, an exterior body that has a first end surface at which the anode part is exposed and a second end surface at which the cathode part is exposed, a first external electrode that covers the first end surface, and a second external electrode that covers the second end surface. The exterior body seals the at least one capacitor element. The first external electrode includes a first conductive paste layer and is electrically connected to the anode part. The second external electrode includes a second conductive paste layer and is electrically connected to the cathode part. Each of the peripheral edge of the first end surface and the peripheral edge of the second end surface is rounded.

### BACKGROUND

### 1. Technical Field

The present disclosure relates to a solid electrolytic capacitor.

### 2. Description of the Related Art

Conventionally, an electrolytic capacitor (solid electrolytic capacitor) using a solid electrolyte has been known (for example, International Publication WO 2009/028183). A solid electrolytic capacitor according to International Publication WO 2009/028183 includes at least one capacitor element each including an anode part and a cathode part, an exterior body that seals at least one capacitor element, a first external electrode electrically connected to the anode part, and a second external electrode electrically connected to the cathode part.

### SUMMARY

One aspect of the present disclosure relates to a solid electrolytic capacitor. The solid electrolytic capacitor includes at least one capacitor element including an anode part and a cathode part, an exterior body that has a first end surface at which the anode part is exposed and a second end surface at which the cathode part is exposed, the exterior body sealing at least one capacitor element, a first external electrode that covers the first end surface, the first external electrode including a first conductive paste layer and being electrically connected to the anode part, and a second external electrode that covers the second end surface, the second external electrode including a second conductive paste layer and being electrically connected to the cathode part. Each of a peripheral edge of the first end surface and a peripheral edge of the second end surface is rounded.

According to the present disclosure, deterioration of equivalent series resistance (ESR) characteristics can be suppressed.

### BRIEF DESCRIPTION OF THE DRAWINGS

FIG. 1 is a cross-sectional view schematically illustrating an example of a solid electrolytic capacitor according to the present disclosure; and

FIG. 2 is a cross-sectional view schematically illustrating a structure of a capacitor element.

### DETAILED DESCRIPTIONS OF EMBODIMENTS

Prior to the description of exemplary embodiments, problems in the related art will be briefly described.

Depending on the configuration of a solid electrolytic capacitor, an external electrode may include a conductive paste layer. In such a case, when a conductive paste layer has a portion with insufficient thickness, peeling of an external electrode or the like that may happen at the portion may cause air to intrude into the inside of an exterior body as far as to a capacitor element, which may deteriorate ESR characteristics of the solid electrolytic capacitor. In view of such a state, the present disclosure provides a solid electrolytic capacitor that suppresses deterioration in ESR characteristics.

While novel features of the present disclosure are set forth in the claims, the present disclosure will be better understood by the following detailed description with the drawings, taken in conjunction with other features of the present application, both as to construction and content.

Hereinafter, an exemplary embodiment of a solid electrolytic capacitor according to the present disclosure will be described by way of examples. The present disclosure is not limited to the examples described below. Although specific numerical values and materials may be provided as examples in the description below, different numerical values and materials may be applied as long as the effects of the present disclosure can be obtained.

A solid electrolytic capacitor according to the present disclosure includes at least one capacitor element, an exterior body, a first external electrode, and a second external electrode.

At least one capacitor element includes an anode part and a cathode part. At least one capacitor element may further include an insulator provided between the anode part and the cathode part to electrically insulate the anode part and the cathode part from each other. The insulator may be, for example, an insulating tape or an insulating resin. When there is a plurality of capacitor elements, a plurality of capacitor elements may be stacked. In this case, a plurality of capacitor elements may be stacked with all the capacitor elements in the same direction or with some of the capacitor elements in different directions.

The anode part may be an anode body included in the capacitor element. The anode body includes a valve metal. The cathode part may be constituted by a solid electrolyte layer covering a part of the anode body, and a cathode lead-out layer disposed on the solid electrolyte layer. A dielectric layer is provided between the anode body and the solid electrolyte layer. The cathode lead-out layer may include a cathode layer covering at least a part of the solid electrolyte layer, and a metal-containing layer covering at least a part of the cathode layer.

Examples of the valve metal constituting the anode body include aluminum, tantalum, niobium, and titanium. The anode body may be a foil of a valve metal or a sintered body of valve metal particles.

The dielectric layer is formed at least on a portion of a surface of the anode body where the cathode is formed. The dielectric layer may be an oxide (for example, aluminum oxide) formed on the surface of the anode body by a liquid phase method such as anodic oxidation or a gas phase method such as vapor deposition and atomic layer deposition.

The solid electrolyte layer is formed on the surface of the dielectric layer. The solid electrolyte layer may contain a conductive polymer. The solid electrolyte layer may further contain a dopant as necessary.

As the conductive polymer, a known polymer used for a solid electrolytic capacitor, such as a x-conjugated conductive polymer, may be used. Examples of the conductive polymer include polymers having, as a basic skeleton, polypyrrole, polythiophene, polyaniline, polyfuran, polyacetylene, polyphenylene, polyphenylene vinylene, polyacene, or polythiophene vinylene. Among these polymers, a polymer that has, as a basic skeleton, polypyrrole, polythiophene, or polyaniline is preferable. Also included in the above-mentioned polymers are a homopolymer, a copolymer of two or more types of monomers, and derivatives of these polymers (substitution products having a substituent group). For example, polythiophene includes poly(3,4-ethylenedioxythiophene) and the like. As the conductive polymer, one type may be used alone, or two or more types may be used in combination.

As a dopant, at least one selected from the group consisting of low molecular anions and polyanions is used, for example. Examples of low molecular anion include, but are not particularly limited to, a sulfate ion, a nitrate ion, a phosphate ion, a borate ion, an organic sulfonate ion, and a carboxylate ion. Examples of dopant that generates organic sulfonate ions include benzenesulfonic acid, p-toluenesulfonic acid, and naphthalenesulfonic acid. Examples of polyanion include, for example, a polymer-type polysulfonic acid, and a polymer-type polycarboxylic acid. Examples of polymer-type polysulfonic acid include a polyvinylsulfonic acid, a polystyrenesulfonic acid, a polyallylsulfonic acid, a polyacrylsulfonic acid, and a polymethacrylsulfonic acid. Examples of polymer-type polycarboxylic acid include a polyacrylic acid and a polymethacrylic acid. Polyanions also include a polyester sulfonic acid and a phenolsulfonic acid novolak resin. However, polyanions are not limited to those listed above.

The solid electrolyte layer may further contain a known additive agent and a known conductive material other than conductive polymers as necessary. Examples of such a conductive material include at least one selected from the group consisting of conductive inorganic materials such as manganese dioxide and TCNQ complex salts.

The cathode layer may include a carbon layer formed on a surface of the solid electrolyte layer and a conductive material layer formed on a surface of the carbon layer. The conductive material layer may be made from silver paste. As the silver paste, a composition containing silver particles and a resin component (binder resin) may be used, for example. As the resin component, a thermoplastic resin may be used, but it is preferable to use a thermosetting resin such as an imide resin and an epoxy resin.

The metal-containing layer may be a layer containing metal powder, or a metal foil. Examples of a layer including a metal layer include a metal paste layer formed using a composition containing metal powder and a resin (binder resin). Examples of a metal paste layer include a silver paste layer containing silver particles and a resin. Examples of a metal foil include a metal foil made of an Al foil, a Cu foil, a valve metal (e.g., aluminum, tantalum, niobium), or an alloy containing a valve metal. A surface of the metal foil may be roughened as necessary.

The exterior body has a first end surface at which the anode part is exposed and a second end surface at which the cathode part is exposed, and seals at least one capacitor element. The exterior body may contain, for example, a cured product of a curable resin composition, and may contain a thermoplastic resin or a thermosetting resin composition containing a thermoplastic resin. The exterior body may include, in addition to the resin composition, a substrate on which the capacitor element is placed. The substrate may be an insulating substrate, a metal substrate, or a stacked substrate (printed substrate) on which front and back surfaces wiring patterns are formed. At least an end surface of the anode part is exposed at the first end surface. The end surface of the anode part may be flush with the first end surface, may protrude outward from the first end surface, or may be recessed inward from the first end surface. At least an end surface of the cathode part is exposed at the second end surface. The end surface of the cathode part may be flush with the second end surface, may protrude outward from the second end surface, or may be recessed inward from the second end surface.

The first external electrode is provided so as to cover the first end surface. The first external electrode includes a first conductive paste layer and is electrically connected to the anode part. The first conductive paste layer may be disposed closest to the first end surface in the first external electrode. The first conductive paste layer may cover the entire first end surface. The first conductive paste layer may contain conductive particles and a resin material. Examples of the conductive particles include, for example, particles of a conductive inorganic material. The resin material may contain, for example, a cured product of a curable resin composition, and may contain a thermoplastic resin or a composition containing a thermoplastic resin. The first conductive paste layer may be, for example, a silver paste layer containing silver particles or silver alloy particles.

The second external electrode is provided so as to cover the second end surface. The second external electrode includes a second conductive paste layer and is electrically connected to the cathode part. The second conductive paste layer may be disposed closest to the second end surface in the second external electrode. The second conductive paste layer may cover the entire second end surface. The second conductive paste layer may contain conductive particles and a resin material. Examples of the conductive particles include, for example, particles of a conductive inorganic material. The resin material may contain, for example, a cured product of a curable resin composition, and may contain a thermoplastic resin or a composition containing a thermoplastic resin. The second conductive paste layer may be, for example, a silver paste layer containing silver particles or silver alloy particles. The composition of the second conductive paste layer may be the same as or different from the composition of the first conductive paste layer.

As a result of intensive studies, the inventor of the present application has found that the thickness of the conductive paste layer included in the external electrode tends to be insufficient particularly at a portion covering a peripheral edge of an end surface of the exterior body (or a corner of the exterior body). This may be caused by a sharp peripheral edge (or a pointy peripheral edge) of the end surface of the exterior body. In contrast, in the present disclosure, each of the peripheral edge of the first end surface and the peripheral edge of the second end surface is rounded. As a result, a sufficient thickness can be secured for the first conductive paste layer covering the peripheral edge of the first end surface and the second conductive paste layer covering the peripheral edge of the second end surface. Therefore, peeling of the first external electrode or the second external electrode is not likely to occur, and deterioration of ESR characteristics of the solid electrolytic capacitor can be suppressed. Note that the method of rounding an edge is not particularly limited. For example, an edge can be rounded by finishing such as centrifugal barrel finishing. Finishing may be performed before forming a first plating layer described later.

The maximum radius of curvature of the rounded edge of the first end surface may be more than or equal to 1.0 times and less than or equal to 1.1 times the minimum radius of curvature of the rounded edge of the first end surface. In this case, the radius of curvature of the rounded edge is substantially constant over the entire peripheral edge of the first end surface. Accordingly, the thickness of the conductive paste layer can be made uniform, so that the variation in ESR among a plurality of solid electrolytic capacitors can be reduced, and moreover, the solid electrolytic capacitor will have good appearance. In the present specification, when the profile of the rounded edge portion corresponds to a circle, the radius of curvature of the rounded edge is defined by the radius of the circle, and when the profile of the rounded edge portion corresponds to an ellipse, the rounded edge is defined by a half the major axis length of the ellipse. The profile of the rounded edge portion may be a profile in a cross section of the solid electrolytic capacitor, the cross section being orthogonal to principal surfaces of the first external electrode and the second external electrode and parallel to the stacking direction of the capacitor elements.

The maximum radius of curvature of the rounded edge of the second end surface may be more than or equal to 1.0 times and less than or equal to 1.1 times the minimum radius of curvature of the rounded edge of the second end surface. In this case, the radius of curvature of the rounded edge is substantially constant over the entire peripheral edge of the second end surface. Accordingly, the thickness of the conductive paste layer can be made uniform, so that the variation in ESR among a plurality of solid electrolytic capacitors can be reduced, and moreover, the solid electrolytic capacitor will have good appearance.

The maximum radius of curvature of the rounded edge of the first end surface may be more than or equal to 0.95 times and less than or equal to 1.05 times the maximum radius of curvature of the rounded edge of the second end surface. In other words, the maximum radius of curvature of the rounded edge of the first end surface and the maximum radius of curvature of the rounded edge of the second end surface may be substantially the same. Accordingly, the thickness of the conductive paste layer corresponding to each end surface can be made uniform, so that the variation in ESR among a plurality of solid electrolytic capacitors can be further reduced, and moreover, the solid electrolytic capacitor will have good appearance.

The minimum radius of curvature of the rounded edge of the first end surface may be more than or equal to 0.95 times and less than or equal to 1.05 times the minimum radius of curvature of the rounded edge of the second end surface. In other words, the minimum radius of curvature of the rounded edge of the first end surface and the minimum radius of curvature of the rounded edge of the second end surface may be substantially the same. Accordingly, the thickness of the conductive paste layer corresponding to each end surface can be made uniform, so that the variation in ESR among a plurality of solid electrolytic capacitors can be further reduced, and moreover, the solid electrolytic capacitor will have good appearance.

The maximum radius of curvature of the rounded edge of each of the first end surface and the second end surface may be more than or equal to 0.02 mm and less than or equal to 0.24 mm. The maximum radius of curvature of more than or equal to 0.02 mm makes it easy to sufficiently secure the thickness of the conductive paste layer covering the rounded-edge portion. The maximum radius of curvature of less than or equal to 0.24 mm lessens disadvantages such as carving of the capacitor element in the exterior body.

The maximum radius of curvature of the rounded edge of each of the first end surface and the second end surface may be more than or equal to 0.0025D and less than or equal to 0.033D, where D is the distance between the first end surface and the second end surface. The maximum radius of curvature of more than or equal to 0.0025D makes it easy to sufficiently secure the thickness of the conductive paste layer covering the rounded-edge portion. The maximum radius of curvature of less than or equal to 0.033D lessens disadvantages such as carving of the capacitor element in the exterior body.

The thickness of the first conductive paste layer may be more than or equal to 10 μm at a portion where the radius of curvature of the rounded edge of the first end surface is minimum. The thickness of the second conductive paste layer may be more than or equal to 10 μm at a portion where the radius of curvature of the rounded edge of the second end surface is minimum. When each conductive paste layer has about this thickness, peeling of the external electrode from the exterior body can be sufficiently suppressed, and furthermore, deterioration of ESR characteristics of the solid electrolytic capacitor can be further suppressed.

The exterior body may contain a filler. The content of the filler in the exterior body may be more than or equal to 70 mass % and less than or equal to 90 mass % with respect to the whole mass of the exterior body. When the content of the filler in the exterior body is more than or equal to 70 mass %, it becomes easy to adjust the radius of curvature of the rounded edge of each end surface so as to be suitable for suppressing deterioration of ESR characteristics. When the content of the filler in the exterior body is less than or equal to 90 mass %, quick forming of the rounded edge of each end surface can be achieved. Examples of the filler include silica (e.g., fused silica), talc, calcium carbonate, and aluminum oxide.

The clastic modulus of the exterior body at 25° C. may be more than or equal to 10 GPa and less than or equal to 30 GPa. When the elastic modulus of the exterior body at 25° C. is more than or equal to 10 GPa, it becomes easy to adjust the radius of curvature of the rounded edge of each end surface so as to be suitable for suppressing deterioration of ESR characteristics. When the elastic modulus of the exterior body at 25° C. is less than or equal to 30 GPa, quick forming of the rounded edge of each end surface can be achieved.

As described above, according to the present disclosure, the thickness of the conductive paste layer covering a corner of the exterior body can sufficiently be secured by forming a rounded edge on the corner, and thereby deterioration of ESR characteristics of the solid electrolytic capacitor can be suppressed.

Hereinafter, an example of the solid electrolytic capacitor according to the present disclosure will be specifically described with reference to the drawings. The constituent elements described above may be used as constituent elements of the solid electrolytic capacitor of the example described below. The constituent elements of the solid electrolytic capacitor as an example described below may be altered based on the above description. The matters described below may be applied to the exemplary embodiment described above. Among the constituent elements of the solid electrolytic capacitor of the example described below, a constituent element that is not essential to the solid electrolytic capacitor according to the present disclosure may be omitted. The following drawings are schematic and do not accurately reflect the shape and number of actual members.

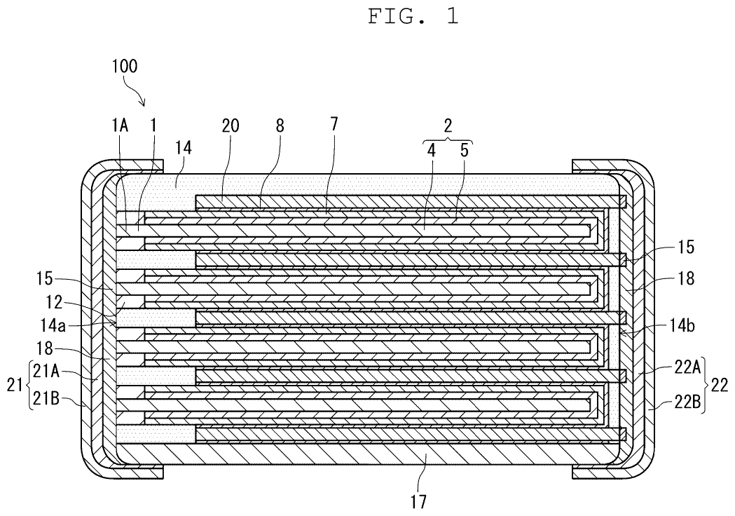

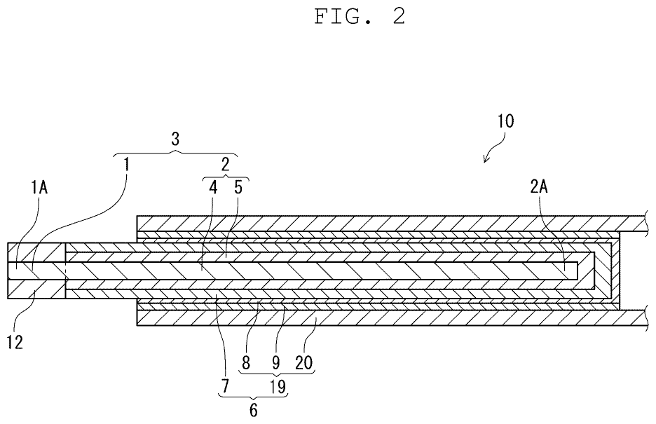

Solid electrolytic capacitor 100 according to the present exemplary embodiment is a solid electrolytic capacitor of an end surface collector type (a type in which an end portion of each capacitor element is exposed from an exterior body, and the exposed portion is electrically connected to an external electrode), but is not limited thereto. As illustrated in FIGS. 1 and 2, solid electrolytic capacitor 100 includes a plurality of capacitor elements 10, exterior body 14, first external electrode 21, and second external electrode 22.

Each of the plurality of capacitor elements 10 includes anode part 3, cathode part 6, and insulator 12 provided between anode part 3 and cathode part 6 to electrically insulates anode part 3 and cathode part 6 from each other. The plurality of capacitor elements 10 is stacked. The plurality of capacitor elements 10 is stacked on substrate 17 (described later) included in exterior body 14. In the present exemplary embodiment, the plurality of capacitor elements 10 is all stacked in the same direction, but the present disclosure is not limited to such a configuration.

Anode part 3 includes an anode body made of a valve metal. Anode part 3 is, for example, an anode foil. Anode part 3 has a surface including porous part 5, and porous part 5 has a surface at least a part of which is provided with a dielectric layer (not illustrated). Cathode part 6 covers at least a part of the dielectric layer.

At one end (first end) 1A of each capacitor element 10, anode part 3 is not covered with cathode part 6 and is exposed. The other end (second end) 2A of each capacitor element 10 is covered with cathode part 6. A part of anode part 3 covered with cathode part 6 (in particular, solid electrolyte layer 7) is referred to as second part 2, and the other part is referred to as first part 1. An end of first part 1 is first end 1A, and an end of second part 2 is second end 2A.

In the illustrated example, second part 2 includes core 4 and porous part 5 formed on a surface of the core 4. First part 1 may have or not have porous part on a surface. The dielectric layer is formed at least on a surface of porous part 5 provided on second part 2.

Cathode part 6 includes solid electrolyte layer 7 covering at least a part of the dielectric layer, and cathode lead-out layer 19 covering at least a part of solid electrolyte layer 7. Cathode lead-out layer 19 may include carbon layer 8 covering at least a part of solid electrolyte layer 7 and metal foil 20 covering at least a part of carbon layer 8.

Metal foil 20 is interposed between second parts 2 of capacitor elements 10 that are adjacent to each other in the stacking direction. Metal foil 20 constitutes a part of cathode part 6 of capacitor element 10, and is shared between capacitor elements 10 that are adjacent in the stacking direction. Adhesive layer 9 having conductivity may be interposed between metal foil 20 and carbon layer 8. Adhesive layer 9 is made of a conductive adhesive, for example. Adhesive layer 9 contains, for example, silver.

Exterior body 14 includes first end surface 14a at which anode part 3 is exposed and second end surface 14b at which cathode part 6 (specifically, metal foil 20 of cathode part 6) is exposed, and seals the plurality of capacitor elements 10. Exterior body 14 is formed in a substantially rectangular parallelepiped shape, and solid electrolytic capacitor 100 is also formed in a substantially rectangular parallelepiped shape. Exterior body 14 includes a resin composition that seals the plurality of capacitor elements 10, and substrate 17 on which the plurality of capacitor elements 10 is stacked. Exterior body 14 includes a filler by more than or equal to 70 mass % and less than or equal to 90 mass % of the whole mass of exterior body 14. The clastic modulus of exterior body 14 at 25° C. is more than or equal to 10 GPa and less than or equal to 30 GPa.

First external electrode 21 is provided so as to cover first end surface 14a of exterior body 14. First external electrode 21 includes first conductive paste layer 21A and is electrically connected to anode part 3. First plating layer 15 is formed to cover an end surface of anode part 3. Electroless Ag plating layer 18 is formed between first end surface 14a and first external electrode 21. Electroless Ag plating layer 18 covers the entire first end surface 14a. First external electrode 21 is electrically connected to an end surface of metal foil 20 of cathode part 6 via electroless Ag plating layer 18 and first plating layer 15. First external electrode 21 includes, for example, first conductive paste layer 21A such as a silver paste layer, and Ni/Sn plating layer 21B covering first conductive paste layer 21A.

Second external electrode 22 is provided so as to cover second end surface 14b of exterior body 14. Second external electrode 22 includes second conductive paste layer 22A and is electrically connected to cathode part 6. First plating layer 15 is formed to cover an end surface of metal foil 20. Electroless Ag plating layer 18 is formed between second end surface 14b and second external electrode 22. Electroless Ag plating layer 18 covers the entire second end surface 14b. Second external electrode 22 is electrically connected to an end surface of metal foil 20 of cathode part 6 via electroless Ag plating layer 18 and first plating layer 15. Second external electrode 22 includes, for example, second conductive paste layer 22A such as a silver paste layer, and Ni/Sn plating layer 22B covering second conductive paste layer 22A.

First plating layer 15 includes at least an electroless Ni plating layer, for example. First plating layer 15 includes, for example, an electroless Ni plating layer and an electroless Ag plating layer covering the electroless Ni plating layer. The electroless Ag plating layer constituting first plating layer 15 may have a composition different from that of electroless Ag plating layer 18. In the illustrated example, first plating layer 15 is formed, but the present exemplary embodiment is not limited to this configuration, and first plating layer 15 may not be formed. Alternatively, although not illustrated, a metal particle layer (for example, a Cu particle layer) may be provided instead of first plating layer 15.

In exterior body 14, the peripheral edge of first end surface 14a and the peripheral edge of second end surface 14b are rounded. The maximum radius of curvature of the rounded edge of first end surface 14a is more than or equal to 1.0 times and less than or equal to 1.1 times the minimum radius of curvature of the rounded edge of first end surface 14a. The maximum radius of curvature of the rounded edge of second end surface 14b is more than or equal to 1.0 times and less than or equal to 1.1 times the minimum radius of curvature of the rounded edge of second end surface 14b. The maximum radius of curvature of the rounded edge of first end surface 14a may be more than or equal to 0.95 times and less than or equal to 1.05 times the maximum radius of curvature of the rounded edge of second end surface 14b. The minimum radius of curvature of the rounded edge of first end surface 14a is more than or equal to 0.95 times and less than or equal to 1.05 times the minimum radius of curvature of the rounded edge of second end surface 14b. The maximum radius of curvature of the rounded edge of each of first end surface 14a and second end surface 14b is more than or equal to 0.02 mm and less than or equal to 0.24 mm. The maximum radius of curvature of the rounded edge of each of first end surface 14a and second end surface 14b is more than or equal to 0.0025D and less than or equal to 0.033D, where D is the distance between first end surface 14a and second end surface 14b.

The thickness of first conductive paste layer 21A is more than or equal to 10 μm at a portion where the radius of curvature of the rounded edge of first end surface 14a is minimum. The thickness of second conductive paste layer 22A is more than or equal to 10 μm at a portion where the radius of curvature of the rounded edge of second end surface 14b is minimum.

### Appendix

The above description of the exemplary embodiment discloses the following techniques.

### Technique 1

A solid electrolytic capacitor including
at least one capacitor element including an anode part and a cathode part,
an exterior body that has a first end surface at which the anode part is exposed and a second end surface at which the cathode part is exposed, the exterior body sealing the at least one capacitor element,
a first external electrode that covers the first end surface, the first external electrode including a first conductive paste layer and being electrically connected to the anode part, and
a second external electrode that covers the second end surface, the second external electrode including a second conductive paste layer and being electrically connected to the cathode part,
wherein each of a peripheral edge of the first end surface and a peripheral edge of the second end surface is rounded.

### Technique 2

The solid electrolytic capacitor according to Technique 1, wherein the maximum radius of curvature of the rounded edge of the first end surface is more than or equal to 1.0 times and less than or equal to 1.1 times the minimum radius of curvature of the rounded edge of the first end surface.

### Technique 3

The solid electrolytic capacitor according to Technique 1 or 2, wherein the maximum radius of curvature of the rounded edge of the second end surface is more than or equal to 1.0 times and less than or equal to 1.1 times the minimum radius of curvature of the rounded edge of the second end surface.

### Technique 4

The solid electrolytic capacitor according to any one of Techniques 1 to 3, wherein the maximum radius of curvature of a rounded edge of the first end surface is more than or equal to 0.95 times and less than or equal to 1.05 times the maximum radius of curvature of a rounded edge of the second end surface.

### Technique 5

The solid electrolytic capacitor according to any one of Techniques 1 to 4, wherein the minimum radius of curvature of a rounded edge of the first end surface is more than or equal to 0.95 times and less than or equal to 1.05 times the minimum radius of curvature of a rounded edge of the second end surface.

### Technique 6

The solid electrolytic capacitor according to any one of Techniques 1 to 5, wherein each of a maximum radius of curvature of a rounded edge of the first end surface and a maximum radius of curvature of a rounded edge of the second end surface is more than or equal to 0.02 mm and less than or equal to 0.24 mm.

### Technique 7

The solid electrolytic capacitor according to any one of Techniques 1 to 6, wherein each of a maximum radius of curvature of a rounded edge of the first end surface and a maximum radius of curvature of a rounded edge of the second end surface is more than or equal to 0.0025D and less than or equal to 0.033D, where D is the distance between the first end surface and the second end surface.

### Technology 8

The solid electrolytic capacitor according to any one of Techniques 1 to 7, wherein
the thickness of the first conductive paste layer is more than or equal to 10 μm at a portion where a radius of curvature of a rounded edge of the first end surface is minimum, and
the thickness of the second conductive paste layer is more than or equal to 10 μm at a portion where a radius of curvature of a rounded edge of the second end surface is minimum.

### Technology 9

The solid electrolytic capacitor according to any one of Techniques 1 to 8, wherein:
the exterior body includes a filler, and
a content of the filler in the exterior body is more than or equal to 70 mass % and less than or equal to 90 mass % with respect to the whole mass of the exterior body.

### Technology 10

The solid electrolytic capacitor according to any one of Techniques 1 to 9, wherein the elastic modulus of the exterior body at 25° C. is more than or equal to 10 GPa and less than or equal to 30 GPa.

Although the present invention has been described in terms of presently preferred exemplary embodiments, such disclosure should not be construed in a limiting manner. Various variations and modifications will become clearly apparent to those skilled in the art to which the present invention pertains upon reading the above disclosure. Thus, the appended claims should be construed to cover all modifications and alterations without departing from the true spirit and scope of the present invention.

The present disclosure can be used for a solid electrolytic capacitor.

What is claimed is:

1. A solid electrolytic capacitor comprising:
at least one capacitor element including an anode part and a cathode part;
an exterior body that has a first end surface at which the anode part is exposed and a second end surface at which the cathode part is exposed, the exterior body sealing the at least one capacitor element;
a first external electrode that covers the first end surface, the first external electrode including a first conductive paste layer and being electrically connected to the anode part; and
a second external electrode that covers the second end surface, the second external electrode including a second conductive paste layer and being electrically connected to the cathode part,
wherein each of a peripheral edge of the first end surface and a peripheral edge of the second end surface is rounded.

2. The solid electrolytic capacitor according to claim 1, wherein a maximum radius of curvature of a rounded edge of the first end surface is more than or equal to 1.0 times and less than or equal to 1.1 times a minimum radius of curvature of the rounded edge of the first end surface.

3. The solid electrolytic capacitor according to claim 1, wherein a maximum radius of curvature of a rounded edge of the second end surface is more than or equal to 1.0 times and less than or equal to 1.1 times a minimum radius of curvature of a rounded edge of the second end surface.

4. The solid electrolytic capacitor according to claim 1, wherein the maximum radius of curvature of a rounded edge of the first end surface is more than or equal to 0.95 times and less than or equal to 1.05 times the maximum radius of curvature of a rounded edge of the second end surface.

5. The solid electrolytic capacitor according to claim 1, wherein the minimum radius of curvature of a rounded edge of the first end surface is more than or equal to 0.95 times and less than or equal to 1.05 times the minimum radius of curvature of a rounded edge of the second end surface.

6. The solid electrolytic capacitor according to claim 1, wherein each of a maximum radius of curvature of a rounded edge of the first end surface and a maximum radius of curvature of a rounded edge of the second end surface is more than or equal to 0.02 mm and less than or equal to 0.24 mm.

7. The solid electrolytic capacitor according to claim 1, wherein each of a maximum radius of curvature of a rounded edge of the first end surface and a maximum radius of curvature of a rounded edge of the second end surface is more than or equal to 0.0025D and less than or equal to 0.033D, where D is a distance between the first end surface and the second end surface.

8. The solid electrolytic capacitor according to claim 1, wherein:
a thickness of the first conductive paste layer is more than or equal to 10 μm at a portion where a radius of curvature of a rounded edge of the first end surface is minimum, and
a thickness of the second conductive paste layer is more than or equal to 10 μm at a portion where a radius of curvature of a rounded edge of the second end surface is minimum.

9. The solid electrolytic capacitor according to claim 1, wherein:
the exterior body includes a filler, and
a content of the filler in the exterior body is more than or equal to 70 mass % and less than or equal to 90 mass % with respect to a whole mass of the exterior body.

10. The solid electrolytic capacitor according to claim 1, wherein an elastic modulus of the exterior body at 25° C. is more than or equal to 10 GPa and less than or equal to 30 GPa.
